(19) United States
(12) Patent Application Publication
(10) Pub. No.: US 2025/0076536 A1
(43) Pub. Date: Mar. 6, 2025

(54) METHOD AND SYSTEM FOR ANALYZING SPATIAL PROBABILITY BASED ON CORRESPONDENCE RELATIONSHIP BETWEEN PRECIPITATION FORECAST AND TELECONNECTION

(71) Applicant: SUN YAT-SEN UNIVERSITY, Guangdong (CN)

(72) Inventors: Tongtiegang ZHAO, Guangdong (CN); Haoling CHEN, Guangdong (CN)

(73) Assignee: SUN YAT-SEN UNIVERSITY, Guangdong (CN)

(21) Appl. No.: 18/279,210

(22) PCT Filed: Jun. 15, 2022
(86) PCT No.: PCT/CN2022/099021

§ 371 Date: Aug. 29, 2023

(51) Int. Cl. G01W 1/10

(52) U.S. Cl. CPC G01W 1/10

(57) ABSTRACT

The present invention provides a method and system for analyzing a spatial probability based on a correspondence relationship between precipitation forecast and teleconnection. The method includes: acquiring a sample sequence of a precipitation forecast to be analyzed and a sample sequence of corresponding observation precipitation and climate indices; respectively calculating a forecast-observation correlation coefficient (FO-CC) and a climate index-observation precipitation teleconnection correlation coefficient (T-CC) of each grid according to the sample sequences, and categorizing each grid according to significance of the FO-CC and the climate index-observation precipitation T-CC; determining a correspondence relationship between the FO-CC and the T-CC according to a grid categorization result; calculating a spatial weight according to spatial coordinates of the grid for acquiring a spatial weight matrix; and calculating a spatial consistent probability where the FO-CC is significantly positive according to the spatial weight matrix and the correspondence relationship between the FO-CC and the T-CC.

### TECHNICAL FIELD

The present invention relates to the technical field of precipitation forecast analysis, and provides a method and system for analyzing a spatial probability based on a correspondence relationship between precipitation forecast and teleconnection.

### BACKGROUND

Scientific and accurate seasonal precipitation forecast is of significant application value in flood control and disaster reduction, resource utilization of flood, reservoir regulation and the like. The (El Nino-Southern Oscillation, ENSO) phenomenon originated from the East Pacific Ocean in the equator plays an important indicating role on global seasonal precipitation. Massive observation data and analytical researches indicate that ENSO can exert an important influence on regional precipitation and even global precipitation through atmospheric teleconnection. Therefore, operational forecast centers of some countries and regions specially target at observation and prediction of ENSO events and provide statistical forecast with abnormal precipitation in the future on this basis. On the other hand, global climate models (GCMs) have been developed stably in recent years, providing abundant meteorological driving data such as precipitation data and air temperature data. These forecast data with considerable precision and long forecast period is gradually applied to operational precipitation forecast.

Recognition and researches on ENSO and a precipitation teleconnection coefficient provide important support for forecasting global seasonal precipitation. Many analytical researches indicate that predictable information of seasonal precipitation forecast is mainly originated from ENSO signals and point out correspondence between ENSO and intensity of the regional precipitation teleconnection coefficient and precipitation forecast precision. The GCMs provide a critical entry point for evaluating the applicability of global seasonal precipitation forecast thanks to the capturing and depicting capacity of the ENSO-precipitation teleconnection coefficient. In actual precipitation forecast evaluation and analysis, it is often difficult to quantitatively depict the Correspondence relationship therebetween by directly comparing the similarity between the forecast precision and the spatial distribution of teleconnection intensity. In addition, correlation coefficients of adjacent regions are usually non-independent but have a strong incidence relation. Conventional precipitation forecast evaluation and analysis methods usually aim at a single grid and neglects the spatial attributes of variables, such that the forecast precision of precipitation forecast cannot be accurately evaluated.

### SUMMARY

To overcome the defect that in existing precipitation forecast evaluation and analysis, it is often difficult to quantitatively depict the correspondence relationship between the forecast precision and the spatial distribution of teleconnection intensity, and the precision of precipitation forecast cannot be accurately evaluated as the spatial attributes of variables are neglected, the present invention provides a method and system for analyzing a spatial probability based on a correspondence relationship between precipitation forecast and teleconnection.

In order to solve the above technical problem, the present invention adopts the technical solution as follows:
a method for analyzing a spatial probability based on a correspondence relationship between precipitation forecast and teleconnection, including the following steps:
acquiring a sample sequence of a precipitation forecast to be analyzed and a sample sequence of corresponding observation precipitation and climate indices;
respectively calculating a forecast-observation correlation coefficient and a climate index-observation precipitation teleconnection correlation coefficient of each grid according to the acquired sample sequences, and categorizing each grid according to significance of the forecast-observation correlation coefficient and the climate index-observation precipitation teleconnection correlation coefficient;
determining a correspondence relationship between the forecast-observation correlation coefficient and the teleconnection correlation coefficient according to a grid categorization result;
calculating a spatial weight according to spatial coordinates of the grid, so as to acquire a spatial weight matrix; and
calculating a spatial consistent probability where the forecast-observation correlation coefficient is significantly positive according to the spatial weight matrix and the correspondence relationship between the forecast-observation correlation coefficient and the teleconnection correlation coefficient.

Further, the present invention further provides a system for analyzing a spatial probability based on a correspondence relationship between precipitation forecast and teleconnection, the system applying the method for analyzing a spatial probability based on a correspondence relationship between precipitation forecast and teleconnection. The system includes a data acquisition module, a correlation coefficient calculation module, a categorization module, a significance determination module, a spatial weight calculation module and a spatial consistent probability analysis module.

In the technical solution, the data acquisition module is configured to acquire the sample sequence of the precipitation forecast to be analyzed and the sample sequence of corresponding observation precipitation and climate indices; the correlation coefficient calculation module is configured to respectively calculate the forecast-observation correlation coefficient and the climate index-observation precipitation teleconnection correlation coefficient of each grid according to the acquired sample sequences; the categorization module is configured to analyze significance of the forecast-observation correlation coefficient and the climate index-observation precipitation teleconnection correlation coefficient and to categorize each grid according to an analysis result; the significance determination module is configured to determine the correspondence relationship between the forecast-observation correlation coefficient and the teleconnection correlation coefficient according to a grid categorization result; the spatial weight calculation module is configured to calculate the spatial weight according to spatial coordinates of the grid, so as to acquire the spatial weight matrix; and the spatial consistent probability analysis module is configured to calculate the spatial consistent probability where the forecast-observation correlation coefficient is positively significant and spatial consistent probability of respective correspondence relationship between the forecast-observation correlation coefficient and different teleconnection correlation coefficients according to the spatial weight matrix and the correspondence relationship between the forecast-observation correlation coefficient and the teleconnection correlation coefficient.

Compared with the prior art, the technical solution of the present invention has the following beneficial effects: by combining the spatial relation for forecasting precipitation with the probability, the spatial consistent probability where the forecast-observation correlation coefficient is significantly positive is quantified, and can be decomposed into the spatial consistent probabilities in different correspondence relationships with the teleconnection effect, so as to provide reference to estimate and select the precipitation forecast product.

### BRIEF DESCRIPTION OF DRAWINGS

FIG. 1 is a flow diagram of a method for analyzing a spatial probability based on a correspondence relationship between precipitation forecast and teleconnection in the embodiment of the present invention.

FIG. 2 is a schematic diagram of a significance categorization result of a forecast-observation correlation coefficient of DJF.

FIG. 3 is a schematic diagram of a significance categorization result of a teleconnection coefficient of DJF.

FIG. 4 is a distribution diagram of a spatial consistent probability where the forecast-observation correlation coefficient is positively significant.

FIG. 5 is a distribution diagram of the spatial consistent probability where the forecast-observation correlation coefficient and the teleconnection coefficient both are positively significant.

FIG. 6 is a distribution diagram of the spatial consistent probability where the forecast-observation correlation coefficient is positively significant and the teleconnection coefficient is non-significant.

FIG. 7 is a distribution diagram of the spatial consistent probability where the forecast-observation correlation coefficient is positively significant and the teleconnection coefficient is negatively significant.

FIG. 8 is an architecture diagram of a system for analyzing a spatial probability based on a correspondence relationship between precipitation forecast and teleconnection in the embodiment of the present invention.

### DETAILED DESCRIPTION OF EMBODIMENTS

The drawings are merely used for exemplary description and are not construed as limitation to the patent.

For those skilled in the art, it can be understood that some known structures and description thereof in the drawings may be omitted.

The technical solution of the present invention will be further described below in combination with the drawings and the embodiments.

### Embodiment 1

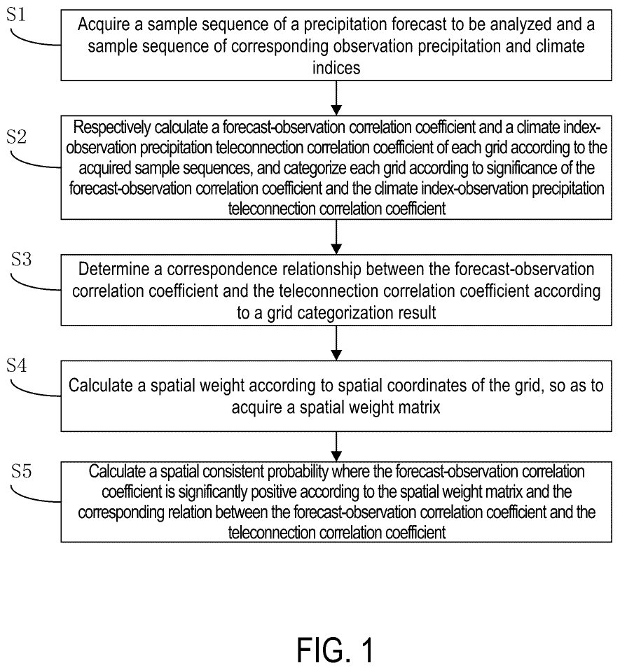

The embodiment provides a method for analyzing a spatial probability based on a correspondence relationship between precipitation forecast and teleconnection. FIG. 1 is a flow diagram of the method for analyzing a spatial probability based on a correspondence relationship between precipitation forecast and teleconnection in the embodiment of the present invention.

The method for analyzing a spatial probability based on a correspondence relationship between precipitation forecast and teleconnection provided in the embodiment includes the following steps:
S1: a sample sequence of a precipitation forecast to be analyzed and a sample sequence of corresponding observation precipitation and climate indices are acquired;
S2: a forecast-observation correlation coefficient and a climate index-observation precipitation teleconnection correlation coefficient of each grid are respectively calculated according to the acquired sample sequences, and each grid is categorized according to significance of the forecast-observation correlation coefficient and the climate index-observation precipitation teleconnection correlation coefficient;
S3: a correspondence relationship between the forecast-observation correlation coefficient and the teleconnection correlation coefficient are determined according to a grid categorization result;
S4: a spatial weight is calculated according to spatial coordinates of the grid, so as to acquire a spatial weight matrix; and
S5: a spatial consistent probability where the forecast-observation correlation coefficient is significantly positive is calculated according to the spatial weight matrix and the correspondence relationship between the forecast-observation correlation coefficient and the teleconnection correlation coefficient.

In the embodiment, by combining the spatial relation for forecasting precipitation with the probability, the spatial consistent probability where the forecast-observation correlation coefficient is significantly positive is quantified, and can be decomposed into the spatial consistent probabilities in different correspondence relationships with the teleconnection effect, so as to provide reference to estimate and select the precipitation forecast product.

In an optional embodiment, the step of respectively calculating a forecast-observation correlation coefficient and a climate index-observation precipitation teleconnection correlation coefficient of each grid in the target region according to the acquired sample sequences includes:
S2.1: forecast precipitation data and observation precipitation data of the grid in a target region are extracted according to the acquired sample sequences;
S2.2: the forecast-observation correlation coefficient r(o, f) is calculated grid by grid, wherein the expression of the forecast-observation correlation coefficient is as follows:

$$r ( o , f ) = \frac{{\sum }_{k} ( {o}_{k} - \overline{o} ) ( {f}_{k} - \overline{f} )}{\sqrt{{\sum }_{k} {( {o}_{k} - \overline{o} )}^{2}} \cdot \sqrt{{\sum }_{k} {( {f}_{k} - \overline{f} )}^{2}}}$$

where oₖ represents the observation precipitation data in the k^{th} year; fₖ represents the forecast precipitation data in the k^{th} year; ō, f̅ respectively represent a mean value of historical observation precipitation data and a mean value of historical forecast precipitation data; and
S2.3: the climate index-observation precipitation teleconnection correlation coefficient r(o, η) is calculated grid by grid, wherein the expression of the climate index-observation precipitation teleconnection correlation coefficient is as follows:

$$r ( o , η ) = \frac{{\sum }_{k} ( {o}_{k} - \overline{o} ) ( {η}_{k} - \overline{η} )}{\sqrt{{\sum }_{k} {( {o}_{k} - \overline{o} )}^{2}} \cdot \sqrt{{\sum }_{k} {( {η}_{k} - \overline{η} )}^{2}}}$$

where ηₖ represents a climate index in the k^{th} year, and η̅ represents a mean value of historical climate indices.

The mean value ō of historical climate indices is calculated according to the sample sequence of historical observation precipitation, wherein the expression of the mean value is as follows:

$$\overline{o} = \frac{{{\sum }^{K}}_{k = 1} {o}_{k}}{K} .$$

where K is the total number of years of the historical sample sequence.

Similarly, the mean value f̅ of historical precipitation forecast data is calculated according to the sample sequence of historical precipitation forecast, wherein the expression of the mean value is as follows:

$$\overline{f} = \frac{{\sum }_{k = 1}^{K} {f}_{k}}{K} .$$

In the embodiment, for teleconnection of El Niño-Southern Oscillation, the common climate index is a Niño3.4 index.

Further, the step of categorizing each grid according to the significance of the forecast-observation correlation coefficient and the climate index-observation precipitation teleconnection correlation coefficient includes:
S2.4: the significance of each grid in the target region is determined and each grid is categorized, according to a predetermined significance level α and the forecast-observation correlation coefficient and the climate index-observation precipitation teleconnection correlation coefficient of each grid;
wherein a probability density function of the correlation coefficient r is estimated by utilizing a Beta function:

$$f ( r ) = \frac{{( 1 - {r}^{2} )}^{n / 2 - 2}}{B ( \frac{1}{2} , \frac{n}{2} - 1 )}$$

where r represents the correlation coefficient, B represents the Beta function and n represents the number of forecast and observation samples for calculating the correlation coefficient. A cumulative probability density function corresponding to the probability density function is denoted as F. At the significance level α, the quantile of 100×(1−α/2) of the correlation coefficient r is represented as r_{1-α/2}:

$${r}_{1 - α / 2} = {F}^{- 1} ( 1 - α / 2 )$$

the quantile of 100×(α/2) of the correlation coefficient r is represented as r_{α/2}:

$${r}_{α / 2} = {F}^{- 1} ( α / 2 ) .$$

Then for the forecast-observation correlation coefficient r(o, f):
if the forecast-observation correlation coefficient r(o, f) is greater than r_{1-α/2}, determining that the forecast-observation correlation coefficient is significantly positive;
if the forecast-observation correlation coefficient r(o, f) is less than or equal to r_{1-α/2}, and greater than r_{α/2}, determining that the forecast-observation correlation coefficient is non-significant; and

if the forecast-observation correlation coefficient r(o, f) is less than r_{α/2}, determining that the forecast-observation correlation coefficient is significantly negative; and

for the climate index-observation precipitation teleconnection correlation coefficient r(o, η):
if the teleconnection correlation coefficient r(o, f) is greater than r_{1-α/2}, determining that the teleconnection correlation coefficient is significantly positive;
if the teleconnection correlation coefficient r(o, f) is less than or equal to r_{1-α/2}, and greater than r_{α/2}, determining that the teleconnection correlation coefficient is non-significant; and
if the teleconnection correlation coefficient r(o, f) is less than r_{α/2}, determining that the teleconnection correlation coefficient is significantly negative; and
at the given significance level α, the grids are categorized into three categories: significantly positive (P), non-significant (ns) and significantly negative (N) according to the significance of their correlation coefficients.

That is, the forecast-observation correlation coefficient r(o, f) can be categorized into three categories:

$$r ( o , f ) ⇒ \{ \begin{matrix}r ( o , f ) > {r}_{1 - α} ⇒ {P}_{A C} \\ {r}_{α / 2} \leq r ( o , f ) \leq {r}_{1 - α} ⇒ n {s}_{A C} \\ r ( o , f ) < {r}_{α / 2} ⇒ {N}_{A C}\end{matrix} .$$

The climate index-observation precipitation teleconnection correlation coefficient r(o, η) can be categorized into three categories:

$$r ( o , η ) ⇒ \{ \begin{matrix}r ( o , η ) > {r}_{1 - α} ⇒ {P}_{ENSO} \\ {r}_{α / 2} \leq r ( o , η ) \leq {r}_{1 - α} ⇒ {ns}_{ENSO} \\ r ( o , η ) < {r}_{α / 2} ⇒ {N}_{ENSO}\end{matrix} .$$

Further, the step of determining the correspondence relationship between the forecast-observation correlation coefficient and the teleconnection coefficient according to the grid categorization result includes: in a case where the forecast-observation correlation is significantly positive, it is determined, grid by grid, that the forecast-observation correlation of the grid is significantly positive and the climate index-observation precipitation teleconnection correlation of the grid is significantly positive, that the forecast-observation correlation is significantly positive of the grid and the climate index-observation precipitation teleconnection correlation of the grid is non-significant, or that the forecast-observation correlation of the grid is significantly positive and the climate index-observation precipitation teleconnection correlation of the grid is significantly negative, and a correspondence relationship vector is constructed through the Boolean number.

In the embodiment, the correspondence relationship between the forecast-observation correlation coefficient and the teleconnection coefficient is determined first where the forecast-observation correlation coefficient r(o, f) is significantly positive, and a correspondence relationship vector is constructed in combination with the Boolean number. The expression of the correspondence relationship vector is as follows:

$$b ( {P}_{A C} \& {P}_{E N S O} ) = {[ {x}_{i} ]}_{N \times 1}$$

$$b ( {P}_{A C} \& n {s}_{E N S O} ) = {[ {x}_{i} ]}_{N \times 1}$$

$$b ( {P}_{A C} \& {N}_{E N S O} ) = {[ {x}_{i} ]}_{N \times 1}$$

where N is the total quantity of the grids in the target region.

b(P_{AC} & P_{ENSO}) represents a Boolean number vector where the forecast-observation correlation is significantly positive P_{AC} and the climate index-observation precipitation teleconnection correlation is significantly positive P_{ENSO}, and when the grid i satisfies P_{AC} & P_{ENSO}, the value of xᵢ is 1, and otherwise the value of xᵢ is 0.

b(P_{AC} & ns_{ENSO}) represents a Boolean number vector where the forecast-observation correlation is significantly positive P_{AC} and the climate index-observation precipitation teleconnection correlation is non-significant ns_{ENSO}, and when the grid i satisfies P_{AC} & ns_{ENSO}, the value of xᵢ is 1, and otherwise the value of xᵢ is 0.

b(P_{AC} & N_{ENSO}) represents a Boolean number vector where the forecast-observation correlation is significantly positive P_{A}c and the climate index-observation precipitation teleconnection correlation is significantly negative N_{ENSO}, and when the grid i satisfies P_{AC} & N_{ENSO}, the value of xᵢ is 1, and otherwise the value of xᵢ is 0.

In an optional embodiment, the step of calculating a spatial weight according to spatial coordinates of the grid, so as to acquire a spatial weight matrix includes:
S4.1: coordinates of the grid in the target region are labeled by taking a top left corner of the target region as an origin;
S4.2: the spatial weights of any two grid coordinates are calculated through a quadratic decay function of a distance, wherein the expressions of the spatial weights is as follows:

$${w}_{ij} = \{ \begin{matrix}\frac{3}{4} ( 1 - {z}^{2} ) , & z \leq 1 \\ 0 , & z > 1\end{matrix}$$

$$z = \frac{{d}_{ij}}{d}$$

$${d}_{ij} = \sqrt{{( {u}_{i} - {u}_{j} )}^{2} + {( {v}_{i} - {v}_{j} )}^{2}}$$

where dᵢⱼ is the Euclidean distance between a grid point (uᵢ, vᵢ) and a grid point (uⱼ, vⱼ) of any grid i and grid j; and d is a bandwidth value of the weight coefficient, and optionally, the value of the bandwidth value of the weight coefficient d is 5; and
S4.3: the spatial weight matrix is constructed according to the spatial weights of any two grid coordinates, wherein the expression of the spatial weight matrix is as follows:

$$W = {[ {w}_{ij} ]}_{N \times N}$$

where N is the total quantity of the grids in the target region.

Further, standardized processing is performed on the spatial weight matrix A, and standardized processing is performed on each spatial weight, wherein the expression of the spatial weight matrix A is as follows:

$$A = {[ \frac{{w}_{ij}}{{\sum }_{i = 1}^{N} {w}_{ij}} ]}_{N \times N} .$$

In the embodiment, row standardization is performed on each weight coefficient to guarantee that the sum of the weight coefficients in each row is equal to 1.

In an optional embodiment, the step of calculating a spatial consistent probability where the forecast-observation correlation coefficient is significantly positive according to the spatial weight matrix A and the correspondence relationship between the forecast-observation correlation coefficient and the teleconnection correlation coefficient includes:
the Boolean number vector where the forecast-observation correlation coefficient of each grid is significantly positive is calculated according to the correspondence relationship between the forecast-observation correlation coefficient and the teleconnection correlation coefficient of each grid in the target region; and then the Boolean number vector is multiplied with the spatial weight corresponding to the grid to calculate the spatial consistent probability where the forecast-observation correlation coefficient of the corresponding grid is significantly positive. The expression of the correspondence relationship vector is as follows:

$$P ( {P}_{A C} ) = A \cdot b ( {P}_{A C} ) = {[ {p}_{i} ]}_{N \times 1}$$

where b(P_{AC}) is the Boolean number vector where the forecast-observation correlation coefficient of the grid is significantly positive, and pᵢ represents the spatial consistent probability where the forecast-observation correlation coefficient of the grid i is significantly positive.

The Boolean number vector b(P_{AC}) where the forecast-observation correlation coefficient of the grid is significantly positive includes the Boolean number vector b(P_{AC}&P_{ENSO}) where the forecast-observation correlation coefficient of the corresponding grid is significantly positive and climate index-observation precipitation teleconnection correlation of the corresponding grid is significantly positive, the Boolean number vector b(P_{AC}&ns_{ENSO}) where the forecast-observation correlation coefficient of the corresponding grid is significantly positive and climate index-observation precipitation teleconnection correlation of the corresponding grid is non-significant, and the Boolean number vector b(P_{AC}&N_{ENSO}) where the forecast-observation correlation coefficient of the corresponding grid is significantly positive and climate index-observation precipitation teleconnection correlation of the corresponding grid is significantly negative.

The spatial consistent probability b(P_{AC}) where the forecast-observation correlation coefficient of the grid is significantly positive calculated includes the spatial consistent probability b(P_{AC}&P_{ENSO}) where forecast-observation correlation of the corresponding grid is significantly positive and climate index-observation precipitation teleconnection correlation is significantly positive, the spatial consistent probability b(P_{AC}&ns_{ENSO}) where forecast-observation correlation of the corresponding grid is significantly positive and climate index-observation precipitation teleconnection correlation is non-significant, and the spatial consistent probability b(P_{AC}&N_{ENSO}) where forecast-observation correlation of the corresponding grid is significantly positive and climate index-observation precipitation teleconnection correlation is significantly negative. The expression of the spatial consistent probability is as follows:

$$\begin{matrix}P ( {P}_{A C} ) = P ( {P}_{A C} \& {P}_{E N S O} ) + P ( {P}_{A C} \& n {s}_{E N S O} ) + P ( {P}_{A C} \& {N}_{E N S O} ) \\ = A \cdot b ( {P}_{A C} \& {P}_{E N S O} ) + A \cdot b ( {P}_{A C} \& n {s}_{E N S O} ) + A \cdot b ( {P}_{A C} \& {N}_{E N S O} ) \\ = {[ {p}_{i} ]}_{N \times 1}\end{matrix}$$

Optionally, in the embodiment, similarly, the spatial consistent probability P(ns_{AC}) where the forecast-observation correlation coefficient is significantly positive and spatial consistent probability P(N_{AC}) where the forecast-observation correlation coefficient is significantly negative can be calculated according to the spatial weight matrix A and the correspondence relationship between the forecast-observation correlation coefficient and the teleconnection correlation coefficient, so as to provide reference to estimate and select the precipitation forecast product.

### Embodiment 2

In the embodiment, the method for analyzing a spatial probability based on a correspondence relationship between precipitation forecast and teleconnection provided in the embodiment 1 is tested.

In the embodiment, by taking monthly precipitation data (1982-2010) in a monthly grid precipitation data set Climate Prediction Center global daily Unified Raingauge Database (CPC-URD) of climate prediction centers of National Oceanic and Atmosphere Administration (NOAA) as the observation data, the observation precipitation in continuously three month is accumulated to obtain seasonal precipitation; climate forecast system version 2 (CFSv2) of National Centers for Environmental Prediction (NCEP) in America is taken as the forecast precipitation data; and the Niño3.4 index represents the ENSO phenomenon.

CFSv2 forecasts precipitation by using the seasonal forecast precipitation with a forecast period of 0 month. Precipitation in December-January-February (DJF) is taken as an example. The spatial resolutions of observation precipitation and forecast precipitation both are 1°×1°.

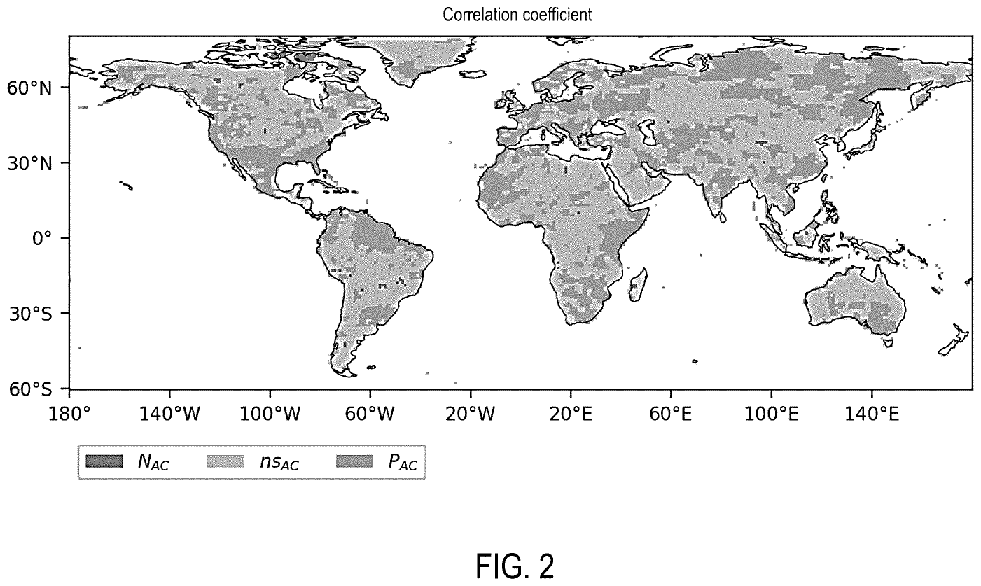

FIG. 2 is the schematic diagram of a significance categorization result of a forecast-observation correlation coefficient of DJF. The grid with moderate gray scale represents that the correlation coefficient is significantly positive, indicating that forecast plays a certain indicating role on observation precipitation. The grid with shallow gray scale represents that the correlation coefficient is non-significant, the grid with deep gray scale represents that the correlation coefficient is significantly negative, and these two categories of grids indicate that the forecast effect is not ideal enough. It can be seen that most grids represent that the forecast-observation correlation coefficient is significantly negative, and next is the grids which represent that the forecast-observation correlation coefficient is significantly positive.

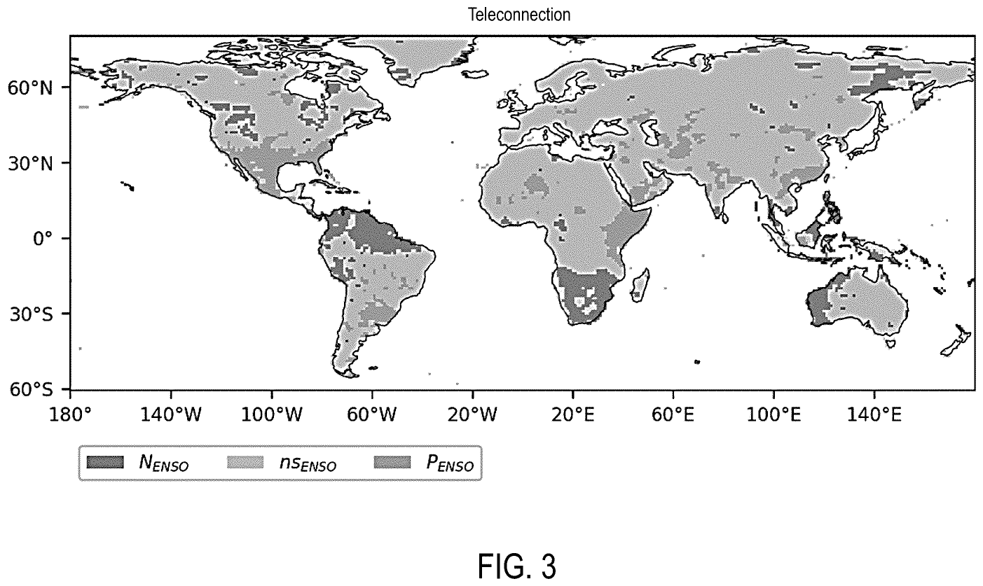

FIG. 2 is the schematic diagram of a significance categorization result of a teleconnection coefficient of DJF. The grid with moderate gray scale represents that the correlation coefficient is significantly positive, the grid with shallow gray scale represents that the correlation coefficient is non-significant, and the grid with deep gray scale represents that the correlation coefficient is significantly negative. Compared with the forecast-observation correlation coefficient, it can be seen that the significance categorization result of the teleconnection coefficient is more continuously distributed in the world. By comparing FIG. 2 with FIG. 3, the similarity of distribution of the significance coefficient in partial region can be seen. For example, in southern North America, northern South America, eastern Africa and the like, the forecast-observation correlation coefficient is significantly positive, and the teleconnection intensity relatively high.

The spatial distribution diagrams of FIG. 2 and FIG. 3 give regional distribution with better forecast effect, which, however, cannot reflect the spatial agglomeration degree of the grids. Meanwhile, correspondence of FIG. 2 and FIG. 3 cannot further give intensity of corresponding degree and consistence of the corresponding space.

Based on FIG. 2, the spatial consistent probability where the forecast-observation correlation coefficient is positively significant is calculated first. The correlation coefficients of each grid and all the grids with a range of 5° centered on the grid are counted and categorized, so as to obtain the spatial consistent probability where the correlation coefficient is significantly positive according to the spatial weight matrix.

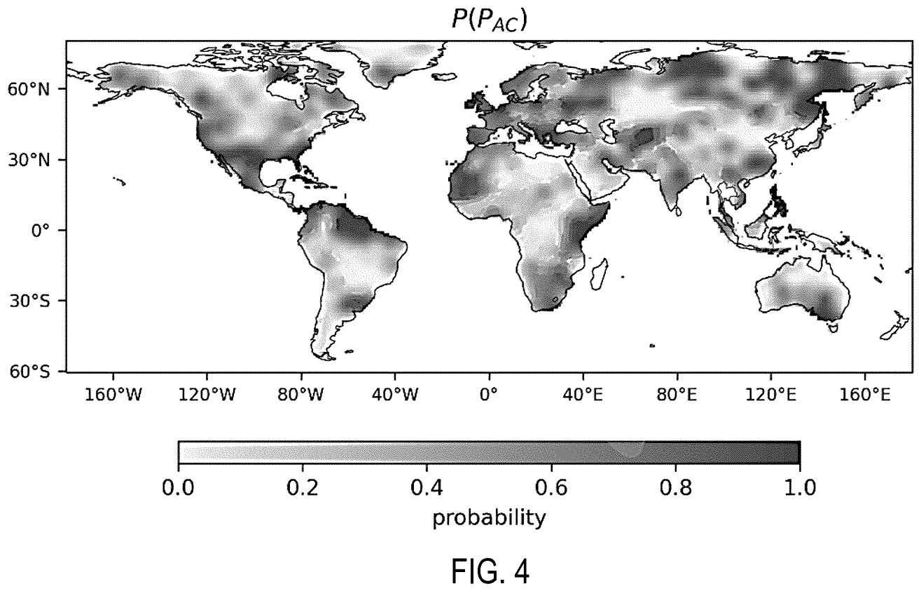

FIG. 4 is a distribution diagram of a spatial consistent probability where the forecast-observation correlation coefficient is positively significant. It can be seen that the condition where the correlation coefficient is significantly positive features high probability in southern North America, northern and southeast South America, eastern and southern Africa, northeast Asia, South China, Southeast Asia, southern Australia and Europe. It means that precipitation forecast has a better effect in these regions.

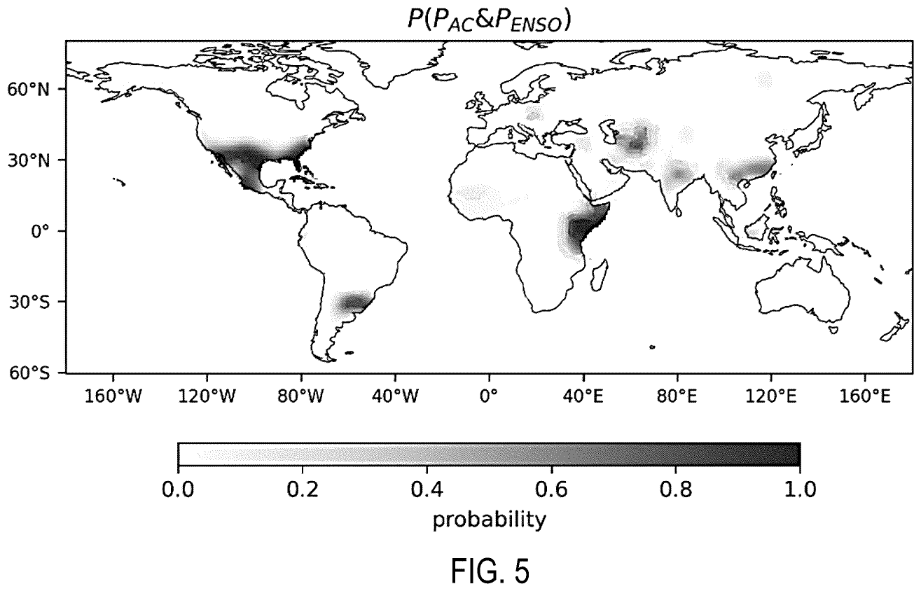

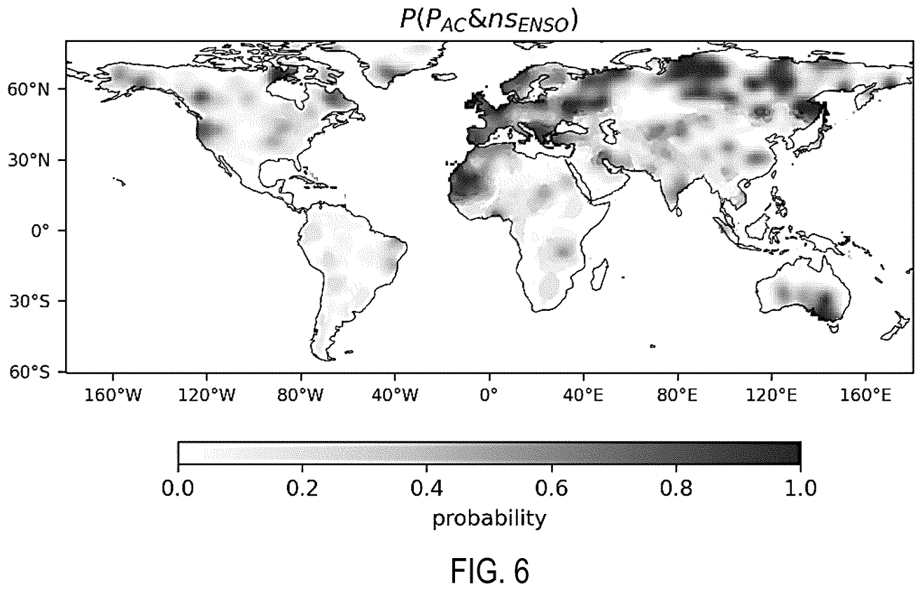

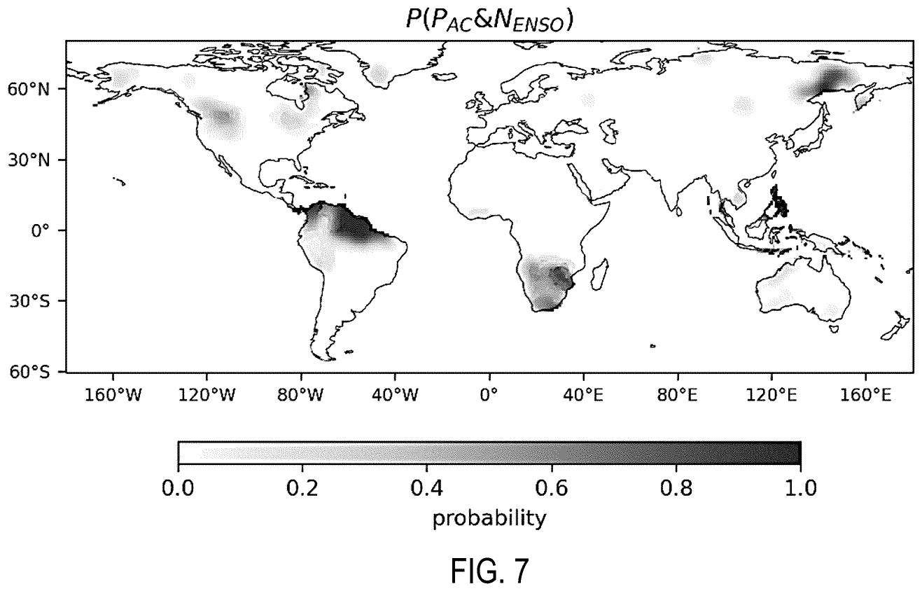

Further, the correspondence relationship between FIG. 2 and FIG. 3 is established. Specifically, FIG. 5 gives a distribution diagram of the spatial consistent probability where the forecast-observation correlation coefficient is positively significant and the teleconnection coefficient is significantly positive. It can be seen that the probability in southern North America, southeast South America, eastern Africa, central Asia and South China is relatively high. The result reflects a strong correspondence relationship between forecast precipitation and teleconnection intensity in these regions. FIG. 6 gives the spatial consistent probability where the forecast-observation correlation coefficient is positively significant and the teleconnection coefficient is non-significant. This kind of condition features high spatial consistent probability in northern Eurasia, southern Australia and northwest Africa. The result reflects a better effect of forecast in regions with weak teleconnection intensity. FIG. 7 gives the spatial consistent probability where the forecast-observation correlation coefficient is positively significant and the teleconnection coefficient is significantly negative. The numerical value of the probability in northeast South America, southern Africa, Southeast Asia and northeast Asia is relatively high.

The spatial consistent probability shown in FIG. 4 is decomposed into three parts by the spatial consistent probability in FIG. 5, FIG. 6 and FIG. 7, thereby facilitating analysis of probable different influence factors of the forecast effect. The above experimental result shows that the method for analyzing the spatial probability provided by the present invention is capable of effectively quantifying the spatial consistent probability where the forecast-observation correlation coefficient is positively significant and decomposing the spatial consistent probability into the spatial consistent probabilities in correspondence relationship with different teleconnection relations, is capable of intuitively exhibiting different correspondence relationship spatial distribution conditions and is capable of providing reference to use forecast services.

### Embodiment 3

The embodiment further provides a system for analyzing a spatial probability based on a correspondence relationship between precipitation forecast and teleconnection, the system applying the method for analyzing a spatial probability based on a correspondence relationship between precipitation forecast and teleconnection provided in the embodiment 1.

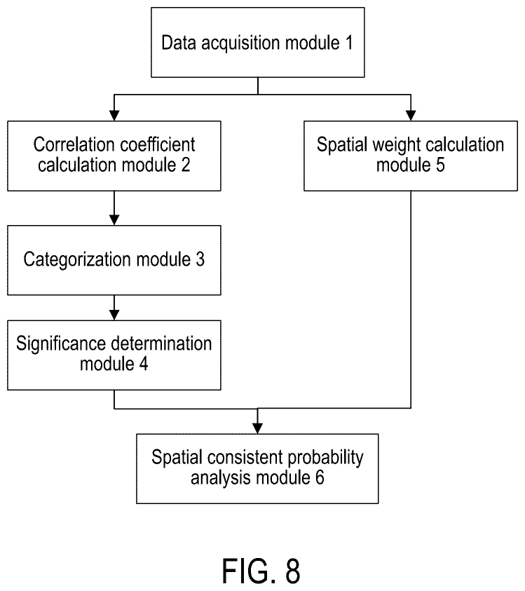

FIG. 8 is an architecture diagram of the system for analyzing a spatial probability based on a correspondence relationship between precipitation forecast and teleconnection in the embodiment.

The system for analyzing a spatial probability based on a correspondence relationship between precipitation forecast and teleconnection provided in the embodiment includes:
a data acquisition module 1, configured to acquire a sample sequence of a precipitation forecast to be analyzed and a sample sequence of corresponding observation precipitation and climate indices;
a correlation coefficient calculation module 2, configured to respectively calculate a forecast-observation correlation coefficient and a climate index-observation precipitation teleconnection correlation coefficient of each grid in the target region, according to the acquired sample sequences;
a categorization module 3, configured to analyze significance of the forecast-observation correlation coefficient and the climate index-observation precipitation teleconnection correlation coefficient and to categorize each grid according to an analysis result;
a significance determination module 4, configured to determine a correspondence relationship between the forecast-observation correlation coefficient and the teleconnection correlation coefficient according to a grid categorization result;
a spatial weight calculation module 5, configured to calculate a spatial weight according to spatial coordinates of the grid, so as to acquire a spatial weight matrix; and
a spatial consistent probability analysis module 6, configured to calculate a spatial consistent probability where the forecast-observation correlation coefficient is significantly positive and spatial consistent probability of respective correspondence relationship between the forecast-observation correlation coefficient and different teleconnection correlation coefficients according to the spatial weight matrix and the correspondence relationship between the forecast-observation correlation coefficient and the teleconnection correlation coefficient.

In an optional embodiment, the categorization module 3 determines the significance of each grid in the target region and categorizes each grid, according to a predetermined significance level α and the forecast-observation correlation coefficient and the climate index-observation precipitation teleconnection correlation coefficient of each grid:
for the forecast-observation correlation coefficient r(o, f):
if the forecast-observation correlation coefficient r(o, f) is greater than r_{1-α/2}, it is determined that the forecast-observation correlation coefficient is significantly positive;
if the forecast-observation correlation coefficient r(o, f) is less than or equal to r_{1-α/2}, and greater than r_{α/2}, it is determined that the forecast-observation correlation coefficient is non-significant; and
if the forecast-observation correlation coefficient r(o, f) is less than r_{α/2}, it is determined that the forecast-observation correlation coefficient is significantly negative; and
for the climate index-observation precipitation teleconnection correlation coefficient r(o, η):
if the teleconnection correlation coefficient r(o, η) is greater than r_{1-α/2}, determining that the teleconnection correlation coefficient is significantly positive;
if the teleconnection correlation coefficient r(o, η) is less than or equal to r_{1-α/2}, and greater than r_{α/2}, it is determined that the teleconnection correlation coefficient is non-significant; and

if the teleconnection correlation coefficient r(o, η) is less than r_{α/2}, it is determined that the teleconnection correlation coefficient is significantly negative.

In an optional embodiment, the significance determination module 4 determines, in a case where the forecast-observation correlation coefficient r(o, f) is significantly positive, grid by grid, that the forecast-observation correlation of the grid is significantly positive and the climate index-observation precipitation teleconnection correlation of the grid is significantly positive, that the forecast-observation correlation of the grid is significantly positive and the climate index-observation precipitation teleconnection correlation of the grid is non-significant, or that the forecast-observation correlation of the grid is significantly positive and the climate index-observation precipitation teleconnection correlation of the grid is significantly negative, and constructs a correspondence relationship vector through the Boolean number.

In an optional embodiment, the spatial weight calculation module 5 further includes a spatial weight matrix A for performing row standardization on each spatial weight.

In an optional embodiment, spatial consistent probability analysis module 6 calculates the Boolean number vector where the forecast-observation correlation coefficient of each grid is significantly positive according to the correspondence relationship between the forecast-observation correlation coefficient and the teleconnection correlation coefficient of each grid in the target region, and then multiplies the Boolean number vector with the spatial weight corresponding to the grid to calculate the spatial consistent probability where the forecast-observation correlation coefficient of the corresponding grid is significantly positive.

The expression of the spatial consistent probability is as follows:

$$P ( {P}_{A C} ) = A \cdot b ( {P}_{A C} ) = {[ {p}_{i} ]}_{N \times 1}$$

where b(P_{AC}) is the Boolean number vector where the forecast-observation correlation coefficient of the grid is significantly positive, and pᵢ represents the spatial consistent probability where the forecast-observation correlation coefficient of the grid i is significantly positive.

The Boolean number vector b(P_{AC}) where the forecast-observation correlation coefficient of each grid is significantly positive includes the Boolean number vector b(P_{AC}&P_{ENSO}) where the forecast-observation correlation coefficient of the corresponding grid is significantly positive and climate index-observation precipitation teleconnection correlation of the corresponding grid is significantly positive, the Boolean number vector b(P_{AC}&ns_{ENSO}) where the forecast-observation correlation coefficient of the corresponding grid is significantly positive and climate index-observation precipitation teleconnection correlation of the corresponding grid is non-significant, and the Boolean number vector b(P_{AC}&N_{ENSO}) where the forecast-observation correlation coefficient of the corresponding grid is significantly positive and climate index-observation precipitation teleconnection correlation of the corresponding grid is significantly negative.

Apparently, the embodiments of the present invention are merely examples made for describing the present invention clearly and are not to limit the embodiments of the present invention. For those of ordinary skill in the pertained field, modifications or variations in other forms may make on the basis of the above description. It is unnecessary to and unable to list all the embodiments herein. Any modification, equivalent replacement, improvement, etc. made within the spirit and principle of the present invention shall be regarded as within the protection scope of the claims of the present invention.

1. A method for analyzing a spatial probability based on a correspondence relationship between precipitation forecast and teleconnection, comprising following steps:
acquiring a sample sequence of a precipitation forecast to be analyzed and a sample sequence of corresponding observation precipitation and climate indices;
respectively calculating a forecast-observation correlation coefficient and a climate index-observation precipitation teleconnection correlation coefficient of each grid according to the acquired sample sequences, and categorizing each grid according to significance of the forecast-observation correlation coefficient and the climate index-observation precipitation teleconnection correlation coefficient;
determining a correspondence relationship between the forecast-observation correlation coefficient and the teleconnection correlation coefficient according to a grid categorization result;
calculating a spatial weight according to spatial coordinates of the grid, so as to acquire a spatial weight matrix; and
calculating a spatial consistent probability where the forecast-observation correlation coefficient is significantly positive according to the spatial weight matrix and the correspondence relationship between the forecast-observation correlation coefficient and the teleconnection correlation coefficient.

2. The method for analyzing the spatial probability based on the correspondence relationship between precipitation forecast and teleconnection according to claim 1, wherein the step of respectively calculating the forecast-observation correlation coefficient and the climate index-observation precipitation teleconnection correlation coefficient of each grid according to the acquired sample sequences comprises:
extracting forecast precipitation data and observation precipitation data of the grid in a target region according to the acquire sample sequence;
calculating the forecast-observation correlation coefficient r(o, f) grid by grid, wherein the expression of the forecast-observation correlation coefficient is as follows:
$$r ( o , f ) = \frac{{\sum }_{k} ( {o}_{k} - \overline{o} ) ( {f}_{k} - \overline{f} )}{\sqrt{{\sum }_{k} {( {o}_{k} - \overline{o} )}^{2}} \cdot \sqrt{{\sum }_{k} {( {f}_{k} - \overline{f} )}^{2}}}$$
where oₖ represents the observation precipitation data in a k^{th} year; fₖ represents the forecast precipitation data in the k^{th} year; ō, f̅ respectively represent a mean value of historical observation precipitation data and a mean value of historical forecast precipitation data; and
calculating the climate index-observation precipitation teleconnection correlation coefficient r(o, η) grid by grid, wherein expression of the climate index-observation precipitation teleconnection correlation coefficient is as follows:
$$r ( o , η ) = \frac{{\sum }_{k} ( {o}_{k} - \overline{o} ) ( {η}_{k} - \overline{η} )}{\sqrt{{\sum }_{k} {( {o}_{k} - \overline{o} )}^{2}} \cdot \sqrt{{\sum }_{k} {( {η}_{k} - \overline{η} )}^{2}}}$$
where ηₖ represents a climate index in the k^{th} year, and η̅ represents a mean value of historical climate indices.

3. The method for analyzing the spatial probability based on the correspondence relationship between precipitation forecast and teleconnection according to claim 1, wherein the step of categorizing each grid according to significance of the forecast-observation correlation coefficient and the climate index-observation precipitation teleconnection correlation coefficient comprises:
determining the significance of each grid in the target region and categorizing each grid, according to a predetermined significance level α and the forecast-observation correlation coefficient and the climate index-observation precipitation teleconnection correlation coefficient of each grid;
for the forecast-observation correlation coefficient r(o, f):
if the forecast-observation correlation coefficient r(o, f) is greater than r_{1-α/2}, determining that the forecast-observation correlation coefficient is significantly positive;
if the forecast-observation correlation coefficient r(o, f) is less than or equal to r_{1-α/2}, and greater than r_{α/2}, determining that the forecast-observation correlation coefficient is non-significant; and
if the forecast-observation correlation coefficient r(o, f) is less than r_{α/2}, determining that the forecast-observation correlation coefficient is significantly negative; and
for the climate index-observation precipitation teleconnection correlation coefficient r(o, η):
if the teleconnection correlation coefficient r(o, η) is greater than r_{1-α/2}, determining that the teleconnection correlation coefficient is significantly positive;
if the teleconnection correlation coefficient r(o, η) is less than or equal to r_{1-α/2}, and greater than r_{α/2}, determining that the teleconnection correlation coefficient is non-significant; and
if the teleconnection correlation coefficient r(o, η) is less than r_{α/2}, determining that the teleconnection correlation coefficient is significantly negative; and
wherein r_{1-α/2} is a quantile of 100×(1−α/2) of the correlation coefficient r, and r_{α/2} is a quantile of 100×(α/2) of the correlation coefficient r.

4. The method for analyzing the spatial probability based on the correspondence relationship between precipitation forecast and teleconnection according to claim 3, wherein the step of determining a correspondence relationship between the forecast-observation correlation coefficient and the teleconnection correlation coefficient according to a grid categorization result comprises:
in a case where the forecast-observation correlation coefficient r(o, f) is significantly positive, determining, grid by grid, that the forecast-observation correlation of the grid is significantly positive and the climate index-observation precipitation teleconnection correlation of the grid is significantly positive, that the forecast-observation correlation of the grid is significantly positive and the climate index-observation precipitation teleconnection correlation of the grid is non-significant, or that the forecast-observation correlation of the grid is significantly positive and the climate index-observation precipitation teleconnection correlation of the grid is significantly negative, and constructing a correspondence relationship vector through the Boolean number, wherein expressions of the correspondence relationship vector is as follows:
$$b ( {P}_{A C} \& {P}_{E N S O} ) = {[ {x}_{i} ]}_{N \times 1}$$
$$b ( {P}_{A C} \& n {s}_{E N S O} ) = {[ {x}_{i} ]}_{N \times 1}$$
$$b ( {P}_{A C} \& {N}_{E N S O} ) = {[ {x}_{i} ]}_{N \times 1}$$
where N is a total quantity of the grids in the target region; b(P_{AC} & P_{ENSO}) is a Boolean number vector where the forecast-observation correlation is significantly positive P_{AC} and the climate index-observation precipitation teleconnection correlation is significantly positive P_{ENSO}, and when a grid i satisfies P_{AC} &P_{ENSO}, a value of xᵢ is 1, and otherwise the value of xᵢ is 0;
where b(P_{AC} & ns_{ENSO}) represents a Boolean number vector where the forecast-observation correlation is significantly positive P_{AC} and the climate index-observation precipitation teleconnection correlation is non-significant ns_{ENSO}, and when the grid i satisfies P_{AC} &ns_{ENSO}, the value of xᵢ is 1, and otherwise the value of xᵢ is 0; and
where b(P_{AC} & N_{ENSO}) represents a Boolean number vector where the forecast-observation correlation is significantly positive P_{AC} and the climate index-observation precipitation teleconnection correlation is significantly negative N_{ENSO}, and when the grid i satisfies P_{AC} &N_{ENSO}, the value of xᵢ is 1, and otherwise the value of xᵢ is 0.

5. The method for analyzing the spatial probability based on the correspondence relationship between precipitation forecast and teleconnection according to claim 1, wherein the step of calculating a spatial weight according to spatial coordinates of the grid, so as to acquire a spatial weight matrix comprises:
labeling coordinates of the grid in the target region by taking a top left corner of the target region as an origin;
calculating the spatial weights of any two grid coordinates through a quadratic decay function of a distance, wherein the expression of the spatial weights is as follows:
$${w}_{ij} = \{ \begin{matrix}\frac{3}{4} ( 1 - {z}^{2} ) , & z \leq 1 \\ 0 , & z > 1\end{matrix}$$
$$z = \frac{{d}_{ij}}{d}$$
$${d}_{ij} = \sqrt{{( {u}_{i} - {u}_{j} )}^{2} + {( {v}_{i} - {v}_{j} )}^{2}}$$
where dᵢⱼ is an Euclidean distance between a grid point (uᵢ, vᵢ) and a grid point (uⱼ, uⱼ), and d is a bandwidth value of the weight coefficient; and
constructing the spatial weight matrix according to the spatial weights of any two grid coordinates, wherein the expression of the spatial weight matrix is as follows:
$$W = {[ {w}_{ij} ]}_{N \times N}$$
where Nis a total quantity of the grids.

6. The method for analyzing the spatial probability based on the correspondence relationship between precipitation forecast and teleconnection according to claim 5, wherein further comprising: performing standardized processing on the spatial weight matrix A, and performing standardized processing on each spatial weight, wherein the expression of the spatial weight matrix A is as follows:
$$A = {[ \frac{{w}_{ij}}{{\sum }_{i = 1}^{N} {w}_{ij}} ]}_{N \times N} .$$

7. The method for analyzing the spatial probability based on the correspondence relationship between precipitation forecast and teleconnection according to claim 1, wherein the step of calculating a spatial consistent probability where the forecast-observation correlation coefficient is significantly positive according to the spatial weight matrix A and the correspondence relationship between the forecast-observation correlation coefficient and the teleconnection correlation coefficient comprises:
calculating the Boolean number vector where the forecast-observation correlation coefficient of each grid is significantly positive according to the correspondence relationship between the forecast-observation correlation coefficient and the teleconnection correlation coefficient of each grid in the target region; and then multiplying the Boolean number vector with the spatial weight corresponding to the grid to calculate the spatial consistent probability where the forecast-observation correlation coefficient of the corresponding grid is significantly positive, wherein the expression of the spatial consistent probability is as follows:
$$P ( {P}_{A C} ) = A \cdot b ( {P}_{A C} ) = {[ {p}_{i} ]}_{N \times 1}$$
where b(P_{AC}) is the Boolean number vector where the forecast-observation correlation coefficient of the grid is significantly positive, and pᵢ represents the spatial consistent probability where the forecast-observation correlation coefficient of the grid i is significantly positive.

8. The method for analyzing the spatial probability based on the correspondence relationship between precipitation forecast and teleconnection according to claim 7, wherein the Boolean number vector b(P_{AC}) where the forecast-observation correlation coefficient of each grid is significantly positive comprises the Boolean number vector b(P_{AC}&P_{ENSO}) where the forecast-observation correlation coefficient of the corresponding grid is significantly positive and climate index-observation precipitation teleconnection correlation of the corresponding grid is significantly positive, the Boolean number vector b(P_{AC}&ns_{ENSO}) where the forecast-observation correlation coefficient of the corresponding grid is significantly positive and climate index-observation precipitation teleconnection correlation of the corresponding grid is non-significant, and the Boolean number vector b(P_{AC}&N_{ENSO}) where the forecast-observation correlation coefficient of the corresponding grid is significantly positive and climate index-observation precipitation teleconnection correlation of the corresponding grid is significantly negative.

9. The method for analyzing a spatial probability based on a correspondence relationship between precipitation forecast and teleconnection according to claim 7, wherein the method further comprises the following step: calculating the spatial consistent probability where the forecast-observation correlation coefficient is non-significant and the forecast-observation correlation coefficient is significantly negative according to the spatial weight matrix A and the correspondence relationship between the forecast-observation correlation coefficient and the teleconnection correlation coefficient.

10. A system for analyzing a spatial probability based on a correspondence relationship between precipitation forecast and teleconnection, the system applying the method for analyzing a spatial probability based on a correspondence relationship between precipitation forecast and teleconnection according to claim 1, wherein the system comprises:
a data acquisition module, configured to acquire a sample sequence of a precipitation forecast to be analyzed and a sample sequence of corresponding observation precipitation and climate indices;
a correlation coefficient calculation module, configured to respectively calculate a forecast-observation correlation coefficient and a climate index-observation precipitation teleconnection correlation coefficient of each grid in the target region, according to the acquire sample sequences;
a categorization module, configured to analyze significance of the forecast-observation correlation coefficient and the climate index-observation precipitation teleconnection correlation coefficient and to categorize each grid according to an analysis result;
a significance determination module, configured to determine a correspondence relationship between the forecast-observation correlation coefficient and the teleconnection correlation coefficient according to a grid categorization result;
a spatial weight calculation module, configured to calculate a spatial weight according to spatial coordinates of the grid, so as to acquire a spatial weight matrix; and
a spatial consistent probability analysis module, configured to calculate a spatial consistent probability where the forecast-observation correlation coefficient is significantly positive and spatial consistent probability of respective correspondence relationship between the forecast-observation correlation coefficient and different teleconnection correlation coefficients according to the spatial weight matrix and the correspondence relationship between the forecast-observation correlation coefficient and the teleconnection correlation coefficient.

11. A system for analyzing a spatial probability based on a correspondence relationship between precipitation forecast and teleconnection, the system applying the method for analyzing a spatial probability based on a correspondence relationship between precipitation forecast and teleconnection according to claim 2, wherein the system comprises:
a data acquisition module, configured to acquire a sample sequence of a precipitation forecast to be analyzed and a sample sequence of corresponding observation precipitation and climate indices;
a correlation coefficient calculation module, configured to respectively calculate a forecast-observation correlation coefficient and a climate index-observation precipitation teleconnection correlation coefficient of each grid in the target region, according to the acquire sample sequences;
a categorization module, configured to analyze significance of the forecast-observation correlation coefficient and the climate index-observation precipitation teleconnection correlation coefficient and to categorize each grid according to an analysis result;
a significance determination module, configured to determine a correspondence relationship between the forecast-observation correlation coefficient and the teleconnection correlation coefficient according to a grid categorization result;
a spatial weight calculation module, configured to calculate a spatial weight according to spatial coordinates of the grid, so as to acquire a spatial weight matrix; and
a spatial consistent probability analysis module, configured to calculate a spatial consistent probability where the forecast-observation correlation coefficient is significantly positive and spatial consistent probability of respective correspondence relationship between the forecast-observation correlation coefficient and different teleconnection correlation coefficients according to the spatial weight matrix and the correspondence relationship between the forecast-observation correlation coefficient and the teleconnection correlation coefficient.

12. A system for analyzing a spatial probability based on a correspondence relationship between precipitation forecast and teleconnection, the system applying the method for analyzing a spatial probability based on a correspondence relationship between precipitation forecast and teleconnection according to claim 3, wherein the system comprises:
a data acquisition module, configured to acquire a sample sequence of a precipitation forecast to be analyzed and a sample sequence of corresponding observation precipitation and climate indices;
a correlation coefficient calculation module, configured to respectively calculate a forecast-observation correlation coefficient and a climate index-observation precipitation teleconnection correlation coefficient of each grid in the target region, according to the acquire sample sequences;
a categorization module, configured to analyze significance of the forecast-observation correlation coefficient and the climate index-observation precipitation teleconnection correlation coefficient and to categorize each grid according to an analysis result;
a significance determination module, configured to determine a correspondence relationship between the forecast-observation correlation coefficient and the teleconnection correlation coefficient according to a grid categorization result;
a spatial weight calculation module, configured to calculate a spatial weight according to spatial coordinates of the grid, so as to acquire a spatial weight matrix; and
a spatial consistent probability analysis module, configured to calculate a spatial consistent probability where the forecast-observation correlation coefficient is significantly positive and spatial consistent probability of respective correspondence relationship between the forecast-observation correlation coefficient and different teleconnection correlation coefficients according to the spatial weight matrix and the correspondence relationship between the forecast-observation correlation coefficient and the teleconnection correlation coefficient.

13. A system for analyzing a spatial probability based on a correspondence relationship between precipitation forecast and teleconnection, the system applying the method for analyzing a spatial probability based on a correspondence relationship between precipitation forecast and teleconnection according to claim 4, wherein the system comprises:
a data acquisition module, configured to acquire a sample sequence of a precipitation forecast to be analyzed and a sample sequence of corresponding observation precipitation and climate indices;
a correlation coefficient calculation module, configured to respectively calculate a forecast-observation correlation coefficient and a climate index-observation precipitation teleconnection correlation coefficient of each grid in the target region, according to the acquire sample sequences;
a categorization module, configured to analyze significance of the forecast-observation correlation coefficient and the climate index-observation precipitation teleconnection correlation coefficient and to categorize each grid according to an analysis result;
a significance determination module, configured to determine a correspondence relationship between the forecast-observation correlation coefficient and the teleconnection correlation coefficient according to a grid categorization result;
a spatial weight calculation module, configured to calculate a spatial weight according to spatial coordinates of the grid, so as to acquire a spatial weight matrix; and
a spatial consistent probability analysis module, configured to calculate a spatial consistent probability where the forecast-observation correlation coefficient is significantly positive and spatial consistent probability of respective correspondence relationship between the forecast-observation correlation coefficient and different teleconnection correlation coefficients according to the spatial weight matrix and the correspondence relationship between the forecast-observation correlation coefficient and the teleconnection correlation coefficient.

14. A system for analyzing a spatial probability based on a correspondence relationship between precipitation forecast and teleconnection, the system applying the method for analyzing a spatial probability based on a correspondence relationship between precipitation forecast and teleconnection according to claim 5, wherein the system comprises:
a data acquisition module, configured to acquire a sample sequence of a precipitation forecast to be analyzed and a sample sequence of corresponding observation precipitation and climate indices;
a correlation coefficient calculation module, configured to respectively calculate a forecast-observation correlation coefficient and a climate index-observation precipitation teleconnection correlation coefficient of each grid in the target region, according to the acquire sample sequences;
a categorization module, configured to analyze significance of the forecast-observation correlation coefficient and the climate index-observation precipitation teleconnection correlation coefficient and to categorize each grid according to an analysis result;
a significance determination module, configured to determine a correspondence relationship between the forecast-observation correlation coefficient and the teleconnection correlation coefficient according to a grid categorization result;
a spatial weight calculation module, configured to calculate a spatial weight according to spatial coordinates of the grid, so as to acquire a spatial weight matrix; and
a spatial consistent probability analysis module, configured to calculate a spatial consistent probability where the forecast-observation correlation coefficient is significantly positive and spatial consistent probability of respective correspondence relationship between the forecast-observation correlation coefficient and different teleconnection correlation coefficients according to the spatial weight matrix and the correspondence relationship between the forecast-observation correlation coefficient and the teleconnection correlation coefficient.

15. A system for analyzing a spatial probability based on a correspondence relationship between precipitation forecast and teleconnection, the system applying the method for analyzing a spatial probability based on a correspondence relationship between precipitation forecast and teleconnection according to claim 6, wherein the system comprises:
a data acquisition module, configured to acquire a sample sequence of a precipitation forecast to be analyzed and a sample sequence of corresponding observation precipitation and climate indices;
a correlation coefficient calculation module, configured to respectively calculate a forecast-observation correlation coefficient and a climate index-observation precipitation teleconnection correlation coefficient of each grid in the target region, according to the acquire sample sequences;
a categorization module, configured to analyze significance of the forecast-observation correlation coefficient and the climate index-observation precipitation teleconnection correlation coefficient and to categorize each grid according to an analysis result;
a significance determination module, configured to determine a correspondence relationship between the forecast-observation correlation coefficient and the teleconnection correlation coefficient according to a grid categorization result;
a spatial weight calculation module, configured to calculate a spatial weight according to spatial coordinates of the grid, so as to acquire a spatial weight matrix; and
a spatial consistent probability analysis module, configured to calculate a spatial consistent probability where the forecast-observation correlation coefficient is significantly positive and spatial consistent probability of respective correspondence relationship between the forecast-observation correlation coefficient and different teleconnection correlation coefficients according to the spatial weight matrix and the correspondence relationship between the forecast-observation correlation coefficient and the teleconnection correlation coefficient.

16. A system for analyzing a spatial probability based on a correspondence relationship between precipitation forecast and teleconnection, the system applying the method for analyzing a spatial probability based on a correspondence relationship between precipitation forecast and teleconnection according to claim 7, wherein the system comprises:
a data acquisition module, configured to acquire a sample sequence of a precipitation forecast to be analyzed and a sample sequence of corresponding observation precipitation and climate indices;
a correlation coefficient calculation module, configured to respectively calculate a forecast-observation correlation coefficient and a climate index-observation precipitation teleconnection correlation coefficient of each grid in the target region, according to the acquire sample sequences;
a categorization module, configured to analyze significance of the forecast-observation correlation coefficient and the climate index-observation precipitation teleconnection correlation coefficient and to categorize each grid according to an analysis result;
a significance determination module, configured to determine a correspondence relationship between the forecast-observation correlation coefficient and the teleconnection correlation coefficient according to a grid categorization result;
a spatial weight calculation module, configured to calculate a spatial weight according to spatial coordinates of the grid, so as to acquire a spatial weight matrix; and
a spatial consistent probability analysis module, configured to calculate a spatial consistent probability where the forecast-observation correlation coefficient is significantly positive and spatial consistent probability of respective correspondence relationship between the forecast-observation correlation coefficient and different teleconnection correlation coefficients according to the spatial weight matrix and the correspondence relationship between the forecast-observation correlation coefficient and the teleconnection correlation coefficient.

17. A system for analyzing a spatial probability based on a correspondence relationship between precipitation forecast and teleconnection, the system applying the method for analyzing a spatial probability based on a correspondence relationship between precipitation forecast and teleconnection according to claim 8, wherein the system comprises:
a data acquisition module, configured to acquire a sample sequence of a precipitation forecast to be analyzed and a sample sequence of corresponding observation precipitation and climate indices;
a correlation coefficient calculation module, configured to respectively calculate a forecast-observation correlation coefficient and a climate index-observation precipitation teleconnection correlation coefficient of each grid in the target region, according to the acquire sample sequences;
a categorization module, configured to analyze significance of the forecast-observation correlation coefficient and the climate index-observation precipitation teleconnection correlation coefficient and to categorize each grid according to an analysis result;
a significance determination module, configured to determine a correspondence relationship between the forecast-observation correlation coefficient and the teleconnection correlation coefficient according to a grid categorization result;
a spatial weight calculation module, configured to calculate a spatial weight according to spatial coordinates of the grid, so as to acquire a spatial weight matrix; and
a spatial consistent probability analysis module, configured to calculate a spatial consistent probability where the forecast-observation correlation coefficient is significantly positive and spatial consistent probability of respective correspondence relationship between the forecast-observation correlation coefficient and different teleconnection correlation coefficients according to the spatial weight matrix and the correspondence relationship between the forecast-observation correlation coefficient and the teleconnection correlation coefficient.

18. A system for analyzing a spatial probability based on a correspondence relationship between precipitation forecast and teleconnection, the system applying the method for analyzing a spatial probability based on a correspondence relationship between precipitation forecast and teleconnection according to claim 9, wherein the system comprises:
a data acquisition module, configured to acquire a sample sequence of a precipitation forecast to be analyzed and a sample sequence of corresponding observation precipitation and climate indices;
a correlation coefficient calculation module, configured to respectively calculate a forecast-observation correlation coefficient and a climate index-observation precipitation teleconnection correlation coefficient of each grid in the target region, according to the acquire sample sequences;
a categorization module, configured to analyze significance of the forecast-observation correlation coefficient and the climate index-observation precipitation teleconnection correlation coefficient and to categorize each grid according to an analysis result;
a significance determination module, configured to determine a correspondence relationship between the forecast-observation correlation coefficient and the teleconnection correlation coefficient according to a grid categorization result;
a spatial weight calculation module, configured to calculate a spatial weight according to spatial coordinates of the grid, so as to acquire a spatial weight matrix; and
a spatial consistent probability analysis module, configured to calculate a spatial consistent probability where the forecast-observation correlation coefficient is significantly positive and spatial consistent probability of respective correspondence relationship between the forecast-observation correlation coefficient and different teleconnection correlation coefficients according to the spatial weight matrix and the correspondence relationship between the forecast-observation correlation coefficient and the teleconnection correlation coefficient.
